(19) United States
(12) Patent Application Publication
(10) Pub. No.: US 2024/0073666 A1
(43) Pub. Date: Feb. 29, 2024

(54) METHOD FOR PROVIDING PROXIMAL USER NETWORKING SERVICE BY MEANS OF NEAR-FIELD COMMUNICATION NETWORK, AND SYSTEM THEREFOR

(71) Applicant: HWACOM CO., LTD., Seoul (KR)

(72) Inventors: Seok Ki KIM, Seoul (KR); Jung In CHOI, Anyang-si (KR); Jae Kyu LEE, Seoul (KR); Keol HEO, Seoul (KR); Hyun Seo LIM, Seoul (KR)

(21) Appl. No.: 18/495,287

(22) Filed: Oct. 26, 2023

Related U.S. Application Data
(63) Continuation of application No. PCT/KR2022/005941, filed on Apr. 26, 2022.

(30) Foreign Application Priority Data
Apr. 26, 2021 (KR) 10-2021-0053807

(51) Int. Cl. H04W 4/80; H04W 4/029

(52) U.S. Cl. CPC H04W 4/80; H04W 4/029

(57) ABSTRACT

The present disclosure relates to a method of providing a proximal user networking service by means of a near-field communication network and a system therefor. Specifically, the present disclosure implements an environment in which, when an ad packet is broadcast using a certain host device, a guest device that receives the ad packet in the vicinity uploads relevant information to a service server, thereby allowing the host device to check guest devices that have been present in proximity thereto in the vicinity.

### CROSS-REFERENCE TO RELATED APPLICATIONS

This application is a Continuation of Application No. PCT/KR2022/005941, filed on Apr. 26, 2022, which in turn claims the benefit of Korean Patent Application No. 10-2021-0053807, filed on Apr. 26, 2021. The entire disclosures of all these applications are hereby incorporated by reference.

### TECHNICAL FIELD

The present disclosure relates to a method of providing a proximal user networking service by means of a near-field communication network and a system therefor. Specifically, the present disclosure implements an environment in which, when an ad packet is broadcast using a certain host device, a guest device that receives the ad packet in the vicinity uploads relevant information to a service server, thereby allowing the host device to check guest devices that have been present in proximity thereto in the vicinity.

### BACKGROUND ART

Over the past decade, smartphones have become popular and network infrastructure has been strengthened, and now various types of content using this hardware and infrastructure are being released. Among the various types of content currently being released, there are a lot of applications that encourage people to meet each other, and most of these applications are designed to connect people so as to have a type of encounter similar to a so-called blind meeting in a situation where information on each other is very limited.

However, the content such as blind meeting applications, or so-called dating applications, have the potential to be abused for crimes because they only expose users' information to a minimum, and are also used to forcefully establish networking between complete strangers with no mutual connection links, and as a result, there is a very high possibility that networking between people will not be carried out properly.

The present disclosure is proposed in consideration of the limitations of the networking method and effectiveness of conventional applications such as those described above, and is to allow a service server to record information on other users passing in the vicinity of a user and provide such information to the user, thereby implementing an environment in which networking can be easily carried out between people who frequently meet in the vicinity or who are engaged in activities in the same area.

The present disclosure is derived from the foregoing problems to solve the technical problems as mentioned above and to provide additional technical elements that cannot be easily invented by those skilled in the art.

### DISCLOSURE OF INVENTION

### Technical Problem

An aspect of the present disclosure is to allow records of other user devices passing around a specific user device to be recorded on a service server, thereby allowing the specific user to later know users that have passed or have been present around him or her.

Furthermore, an aspect of the present disclosure is to allow the service server to provide the above-described proximal user information to the specific user, thereby performing networking based on spatiotemporal commonality between the specific user and proximal users passing by.

In addition, an aspect of the present disclosure is to estimate how close other users are in the vicinity, that is, to distinguish closer users among proximal users through estimating the proximity distance without simply considering proximity, thereby more easily performing networking.

Technical problems of the present disclosure are not limited to the above-mentioned problems, and other technical problems which are not mentioned herein will be clearly understood by those skilled in the art from the description below.

### Technical Solution

In order to solve the foregoing problems, a method of providing, by a service server, a proximal user networking service according to the present disclosure may include receiving proximity context information from a second user device; and recording proximal user information based on a first user device based on the proximity context information, wherein the proximity context information comprises at least part of information in an ad packet received by the second user device from the first user device through a near-field communication network.

Furthermore, in the method of providing a proximal user networking service, the ad packet may include a UUID for identifying a service provided by the service server, and further include a community identifier for identifying a community established by a user of the first user device; or a user identifier for identifying the user of the first user device.

Furthermore, in the method of providing a proximal user networking service, the proximity context information may include at least the community identifier or user identifier, and further include timestamp information that records a time point at which an ad packet was received from the first user device; or duration information that records a time period of coexistence within an effective near-field communication network between the first user device and the second user device.

Furthermore, in the method of providing a proximal user networking service, the proximity context information may further include RSSI information that records a reception strength when the second user device receives the ad packet.

Furthermore, the method of providing a proximal user networking service may further include, subsequent to performing, by the service server, recording proximal user information based on the first user device, transmitting at least part of the proximal user information to the first user device.

Furthermore, the method of providing a proximal user networking service may further include receiving, by the service server, a community participation request that makes a request for participation in a community established by a user of the first user device from the second user device.

On the other hand, a method of operating a device to provide a proximal user networking service according to another embodiment of the present disclosure may include receiving a first ad packet from a first user device; generating proximity context information comprising at least part of information included in the first ad packet; and transmitting the proximity context information to a service server.

Furthermore, the method of operating a device to provide a proximal user networking service may further include generating a second ad packet with reference to information included in the received first ad packet; and broadcasting the second ad packet.

On the other hand, a method of operating a device to provide a proximal user networking service according to still another embodiment of the present disclosure may include broadcasting an ad packet to arbitrary user devices; receiving proximal person information from a service server; and displaying at least part of the proximal person information through a screen of the device.

Furthermore, in the method of operating a device to provide a proximal user networking service, the displaying of at least part of the proximal person information through the screen of the device may further include displaying GPS information acquired by the device itself. Furthermore, at this time, the GPS information acquired by the device itself may be encrypted by the device and then shared with the service server.

### Advantageous Effects

According to the present disclosure, there is an effect of providing an environment in which users can network with one another based on spatiotemporal commonality.

In particular, according to the present disclosure, mutual exchange may be implemented after checking a significant level of commonality in time and space, thereby having an effect of increasing safety compared to conventional blind networking in which personal information or contact information is unknown.

In addition, according to the present disclosure, not only proximity but also a degree of proximity may be estimated as a distance value, thereby having an effect of allowing a user to refer to it during networking.

On the other hand, the effects of the present disclosure may not be limited to the above-mentioned effects, and other technical effects which are not mentioned herein will be clearly understood by those skilled in the art from the description below.

### BRIEF DESCRIPTION OF THE DRAWINGS

FIG. 1 systematically shows a basic environment in which a proximal user networking service is provided according to the present disclosure.

FIG. 2 shows a first embodiment according to the present disclosure.

FIG. 3 exemplarily shows proximal user information recorded on a service server.

FIG. 4 shows a second embodiment according to the present disclosure.

FIG. 5 briefly shows a context when a guest device passes in the vicinity of a host device.

FIG. 6 exemplarily shows proximal user information on proximal users who were present in the vicinity of the host device.

FIG. 7 shows a figure in which a host device shares encrypted absolute location information with a service server.

FIG. 8 shows a figure in which location information is further displayed in the proximal user information as shown above in FIG. 6.

FIG. 9 shows a figure in which proximity distance information is further displayed in the proximal user information as shown above in FIG. 6.

FIG. 10 shows an example of proximal user information provided to a host device.

### BEST MODE FOR CARRYING OUT THE INVENTION

The details of the objects and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted or used to limit the scope of the present disclosure. Furthermore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

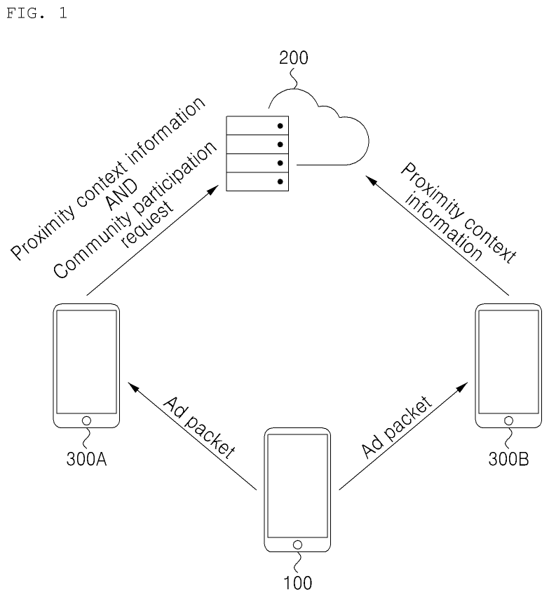

First, FIG. 1 systematically shows a basic environment in which a proximal user networking service according to the present disclosure can be provided. According to FIG. 1, an entire system may include a first user device 100 that can be defined as a host device, a service server 200 that provides a proximal user networking service, and second user devices 300A, 300B that are present in proximity to, in the vicinity of the first user device 100. For reference, it is stated in advance that in this detailed description, the first user device will be referred to as a host device, and other user devices will be referred to as guest devices.

A representative example context based on FIG. 1 is as follows. The first user device 100 may be configured to broadcast ad packets to the surrounding area using a near-field network (e.g., a Bluetooth network) while establishing a community, that is, a kind of chat room. That is, the first user device 100 creates a chat room as a host and broadcasts packets (ad packets) to notify other user devices of the chat room or the user himself or herself to other connectable user devices in a nearby near-field network, thereby operating with the purpose of allowing other users to receive it.

Meanwhile, the second user devices 300A, 300B may receive an ad packet from the foregoing first user device 100, and transmit information related to the proximity context, that is, information such as which device the second user device 300A, 300B received the ad packet from, what time it received the ad packet, how long it was in proximity to another user device, and the like, to the service server 200 based on information acquired from the ad packet according to settings. That is, it is to be understood that the second user devices 300A, 300 B are those in proximity to the first user device 100, with a configuration in which if an ad packet is received from the first user device 100 through a near-field network, then proximity context information based thereon is transmitted to the service server 200 and recorded therein. Meanwhile, among the second user devices, a community participation request may be transmitted so that the user can participate in a community (chat room) established by the first user device 100, that is, the host device, if desired.

Lastly, the service server 200 performs the role of receiving proximity context information from the second user devices 300A, 300B as described above, and recording the proximity context information. In addition, the service server 200 may not simply perform the role of receiving and recording proximity context information, but also perform the role of recommending users who are capable of networking among nearby users to the user of the first user device 100, that is, the host device, from the recorded proximity context information.

Furthermore, in addition to the above-mentioned functions, the service server 200 may perform the role of opening a community (chat room) in response to a request for opening the community, that is, when receiving a request for establishing the chat room, from devices, and maintaining an access to other devices. At this time, when connected to the service server 200, other devices may be connected through a wide area network (LTE, etc.) rather than a near-field network.

Additionally, the service server 200 according to the present disclosure may be implemented to allow each user to participate in a community or share data or information through a link with an SNS server. That is, through the service server 200 according to the present disclosure, so-called non-members who have not previously registered may use a service according to the present disclosure by means of the login information of other SNS services, and furthermore, files that are being shared through the other SNS services may be implemented to be shared also in each community through the service server.

Meanwhile, each configuration shown in FIG. 1 may have the following hardware features. First, with regard to a device (herein, the device includes a host device and guest devices around the host device), the device mentioned in the detailed description refers to an apparatus owned or carried by a user, and may include a portable terminal such as a smartphone, a PDA, and a tablet PC, as well as an installed terminal such as a home PC or the like. Considering the device in terms of an apparatus, it is assumed that each device has a central processing unit (CPU) and a memory. The central processing unit may also be referred to as a controller, a microcontroller, a microprocessor, a microcomputer, or the like. Furthermore, the central processing unit may be implemented by hardware or firmware, software, or a combination thereof, and configured to include an application specific integrated circuit (ASIC) or a digital signal processor (DSP), a digital signal processing device (DSPD), a programmable logic device (PLD), or a field programmable gate array (FPGA) when implemented using hardware, and configured with firmware or software to include a module, a procedure, a function or the like that performs the foregoing functions or operations when implemented using firmware or software. In addition, the memory may be implemented as Read Only Memory (ROM), Random Access Memory (RAM), Erasable Programmable Read Only Memory (EPROM), Electrically Erasable Programmable Read-Only Memory (EEPROM), flash memory, Static RAM (SPAM), a hard disk drive (HDD), a solid-state drive (SSD) or the like.

For reference, in this detailed description, it will be described on the assumption that the device is a smartphone or a tablet PC to help understand the present disclosure. In this case, the device may include a display and a touch-sensitive surface, and may additionally be connected to one or more other means for physical user input, such as a physical keyboard, mouse and/or joystick. In addition, the device may further include a means for sensing and recording sound or voice. Meanwhile, various applications executed on the device may optionally use at least one common means for physical user input, such as a touch-sensitive surface. One or more functions of the touch-sensitive surface and corresponding information displayed on the terminal may be optionally adjusted or changed from one application to a next application and/or within an individual application. In this manner, the common physical architecture of the device (such as the touch-sensitive surface) may optionally support a variety of applications using user interfaces that are intuitive and clear to the user.

Meanwhile, the service server 200 is a configuration for providing a program, that is, a set of instructions, for actually implementing the method according to the present disclosure, which furthermore corresponds to a configuration for processing or storing various types of data received from a plurality of terminals. The type of the service server 200 may be at least one server PC managed by a specific operator or may be a type of cloud server provided by another company, that is, a type of cloud server that the operator can sign up to use. In particular, when the service server is implemented as a server PC, the service server may include a central processing unit and a memory, which has been described above in detail in the description of the device, and thus a description thereof will be omitted herein.

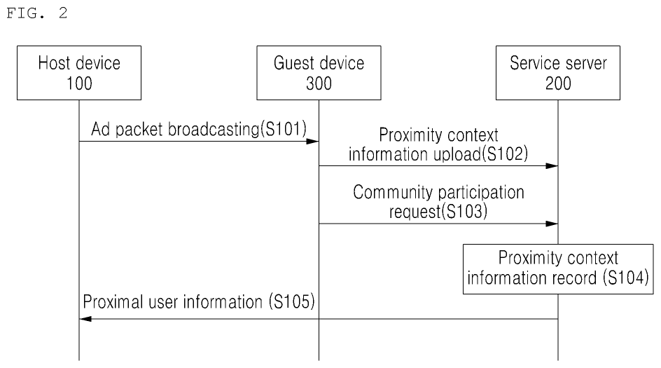

FIG. 2 shows a method of providing a proximal user networking service according to a first embodiment of the present disclosure.

Referring to FIG. 2, the first embodiment may first of all begin with broadcasting, by the host device 100, an ad packet to a certain guest device 300 (S101). An ad packet may be understood as a data packet generated by a device to be transmitted to the outside through a near-field network, for example, a Bluetooth network. The ad packet may include a UUID, which is an identifier for identifying a service provided by the service server 200, and in addition thereto, may further include a community identifier for identifying a community (chat room) previously established by the user, or a user identifier for identifying the relevant user. That is, the ad packet may basically include an identifier for identifying a service provided by the service server 200 according to the present disclosure, and an identifier for identifying a chat room or user, and such an ad packet may be broadcast to any guest devices for promotional purposes.

Meanwhile, the ad packet may further include a counting value (TTL) for controlling the number of guest devices desired to additionally participate in the community, or a direct field for identifying whether it is an ad packet sent directly from the host device 100.

With regard to the counting value, the counting value (TTL) is a value for limiting the number of guests, wherein when a counting value broadcast from the host device 100 is n, devices that received it reduce the counting value by 1 and broadcast the reduced counting value again, and finally, when the counting value is 0, broadcasting may no longer be carried out. Meanwhile, preferably, the counting value may have a maximum value of 63.

With regard to the direct field, in the present disclosure, serial broadcasting through a Bluetooth mesh network may be performed using a counting value, and in some cases, it may be necessary to check which nodes among any guest devices, that is, any nodes, have received the ad packet directly from the host device 100. The direct field may be set to a true value in the ad packet sent by the host device 100, but guest devices that receive it may change the value of the direct field to false to enable broadcasting. In this case, only nodes that directly have received the ad packet from the host device 100 will have a true value in the direct field, so the host device 100 and the guest devices closest thereto may be distinguished. In addition, in some cases, it may be possible to estimate that the devices that have received the ad packet with the direct field being true are within a certain distance, for example, about 40 meters (this is a value that can be adjusted depending on the designer's intention), thereby providing various additional services or providing additional information to proximity devices.

Subsequent step S101, the guest device 300 may refer to some of the information included in the previously received ad packet to generate context information related to receiving the ad packet and upload it to the service server 200 (S102). In this detailed description, the above context information will be referred to as proximity context information. The proximity context information may include various parameters when a guest device receives an ad packet from a host device. The proximity context information may include, for example, timestamp information recording a time point at which an ad packet was received from the host device, or duration information that records a time period of coexistence within an effective near-field communication network between the host device and the guest device.

Furthermore, the proximity context information may also include RSSI information that records a reception strength when the guest device receives an ad packet from the host device, and/or Measured Power information indicating a strength value of a signal measured at a reference distance.

In summary, the guest device 300 may generate proximity context information based on an ad packet received from the host device 100 and transmits it to the service server 200, and at this time, the proximity context information may include time stamp information, duration information, RSSI information, or Measured Power information.

For reference, although not separately mentioned, the proximity context information may further include an identifier that can identify which device the ad packet was broadcast from, for example, a community (chat room) identifier, or a user identifier, and additionally, may further include a service identifier for identifying this service itself.

In addition, for reference, the guest device 300 may be set not to receive ad packets broadcast from external devices through its own hardware settings or through settings in an application installed to use this service. Furthermore, even when a broadcasted ad packet is received, proximity context information may be generated therefrom on purpose, and thus the guest device may also be set not to transmit it to the service server 200. In other words, this service allows users to prevent their personal information from being leaked against their will through performing steps such as receiving ad packets or transmitting proximity context information to the outside entirely according to the device user's will.

Meanwhile, subsequent to step 102, the guest device 300 may transmit a community participation request to the service server 200 (S103), thereby showing his or her will to participate in the community (chat room) established by the user of the host device 100. This step may be optionally performed when the user of the guest device 300 wants, and for example, this step may be carried out when a message asking if he or she wants to participate in the community (chat room) is displayed on a screen of the guest device 300, and an input of approval is received from the user.

Meanwhile, subsequent to step S102 or step S103, the service server 200 may record the previously received proximity context information in a storage space within the service server 200 or in a storage space provided separately outside the service server 200.

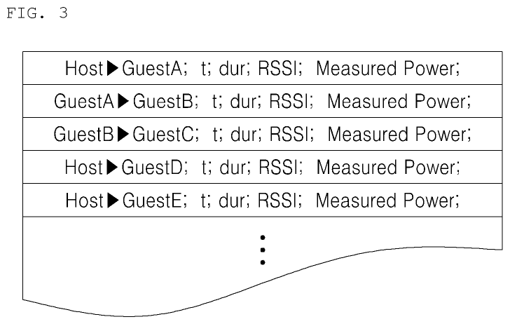

FIG. 3 shows an example of proximity context information recorded by the service server 200. Referring to FIG. 3, the service server 200 may record at least information such as from whom an ad packet was delivered (who were the sender and receiver), a time point at which the ad packet was received, how long period of time it was taken to send and receive the ad packet between the sender and receiver, how long the sender and receiver coexisted within the same space where they could be connected through a near-field network, what was the RSSI when receiving the ad packet, or what was the Measured Power when receiving the ad packet, and the like.

For reference, the proximity context information recorded by the service server 200 may differ in data format from the proximity context information uploaded by the guest device 300. In other words, the service server 200 may acquire only necessary information from the received proximity context information, process the acquired information into a new form of information, and record the processed information.

Finally, the service server 200 may deliver proximal person information to the host device 100 by transmitting information on users or devices that were present in the vicinity of the host device 100 (S105). The proximal person information may be provided in the form of a table or configured with various other interfaces, which may include information on other users who were present in the vicinity of the host device 100, and parameters at the time when other user devices were present in the vicinity. At this time, the parameters may include information in the proximity context information described above, and additionally herein, may further include parameters that can be acquired based on the host device 100 (e.g., GPS information by time of the host device, etc.). Meanwhile, the parameters that can be acquired based on the host device 100 may be merged and displayed when the proximity information is received from the service server 200 and then displayed on the screen through an application of the host device 100. For example, when proximal person information is received from the service server 200 while the host device 100 records and stores the GPS information on its own, the host device 100 may retrieve the GPS information in the corresponding time zone by referring to time-point and time-period related information included in the proximal person information, and display place information mapped with the retrieved GPS information on the screen while at the same time displaying the proximal person information. By doing this, the user of the host device 100 may easily know when, at which place, and with which proximal users he or she was in the same space.

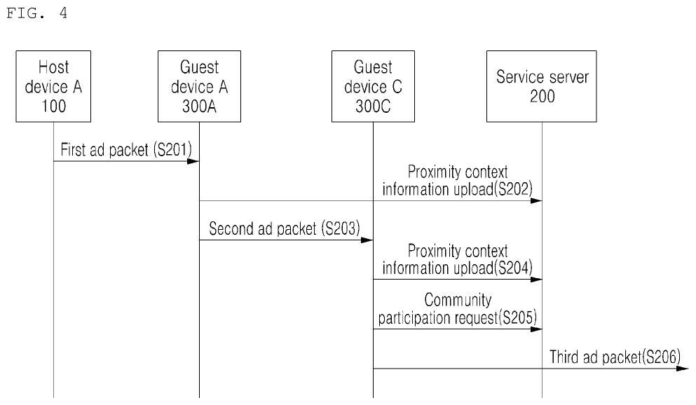

FIG. 4 shows a method of providing a proximal user networking service according to a second embodiment of the present disclosure, wherein in the second embodiment, it can be seen that two guest devices are associated with each other.

Referring to FIG. 4, the second embodiment may first of all begin with receiving, by a guest device A 300A, a first ad packet from the host device 100 (S201). This step is substantially the same as the ad packet transmission/reception step described in the first embodiment, and information included in the ad packet is also substantially the same, and thus a detailed description thereof will be omitted herein.

Next, the guest device A 300A may generate proximity context information, and transmit (upload; S202) the proximity context information to the service server 200, thereby storing parameters related to a proximate context between the host device 100 and the guest device A 300A in the service server 200.

Additionally, the guest device A 300A may generate the second ad packet and broadcast the generated second ad packet to nearby devices, and a guest device C 300C may receive the above second ad packet. The second ad packet may include at least one of an identifier (UUID) for identifying a service, a community identifier capable of identifying a community (chat room) established by the host device 100, a user identifier capable of identifying a user of the guest device A 300A or an individual user of the host device 100, and a counting value.

Meanwhile, a guest device C 300C that has received the second ad packet may generate proximity context information on its own and upload it to the service server 200 (S204), and at the same time, make a request for participation in a community (chat room) established by the host device 100 (S205).

Besides, finally, the guest device C 300C may generate a third ad packet and broadcast it to other devices (S206).

Compared to the first embodiment, the second embodiment has a difference in that the service server 200 does not receive an ad packet directly from the guest device C 300C, that is, the host device 100, but receives proximity context information from a device that has received the ad packet through another device, the guest device A 300A. That is, the proximal user networking service according to the present disclosure may allow the user of the host device 100 to check not only a most proximate user who has received the ad packet directly from the host device 100, but also a proximal user who has received the ad packet through another device, thereby allowing networking even for proximal users in a wider range.

Meanwhile, when a guest device receives an ad packet from another guest device, in a case where some of parameter values for a context when receiving the ad packet do not satisfy a preset range, proximity context information may be disallowed from being uploaded to the service server 200, thereby preventing records from being separately remained on devices that are too far away from the host device 100. For example, the counting value included in an ad packet decreases by 1 as broadcasting is repeated, and thus a range thereof may be limited such that proximity context information is no longer uploaded to the service server 200 when the counting value in the ad packet received from an arbitrary device is less than a specific value (e.g., 2), or the proximity context information is no longer uploaded when the RSSI value is lower than a specific setting value while receiving the ad packet.

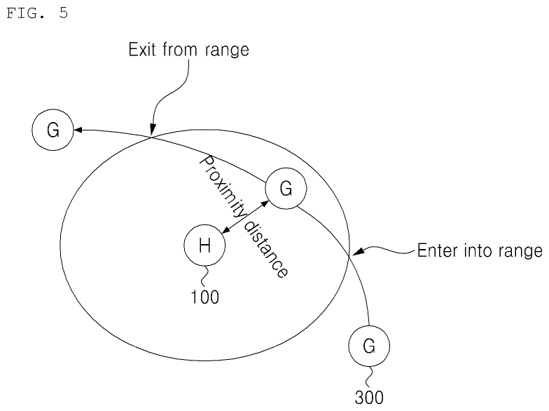

FIG. 5 schematically shows the guest device 300, which is in proximity to the host device 100, passing through a surrounding area of the host device 100. When the guest device 300 and the host device 100 pass through surrounding areas with each other, two functions may mainly operate in the host device 100 or the guest device 300, one of which is a monitoring function that checks whether any device has entered into or exited from the surrounding area, and the other one of which is a ranging function that checks a distance from the guest device that has entered into the surrounding area.

Between the two, the monitoring function may be executed by an OS in the background of the host device 100 or the guest device 300, and may be understood as searching for whether a connectable device is present within a near-field network.

Meanwhile, the ranging function may be executed through an application installed in the host device 100 or the guest device 300, and a distance to a device in proximity thereto is calculated from the RSSI and Measured Power values included in an ad packet received by each.

For example, a distance between two devices may be estimated through the following equation. In Equation 1 below, N may be an arbitrary constant that can be determined by the communication environment, and there is no limit to a range of the number, but preferably has a value between 2 and 4.

$$distance = {10}^{\frac{( MeasuredPower - RSSI )}{( 10 * N )}} \qquad [ Formula 1 ]$$

On the other hand, the estimation of a distance between two devices may be made based on data pre-mapped between RSSI and distance, for example, b1 meters when the RSSI has a value of a1, b2 meters when the RSSI has a value of a2 . . . in such a manner that can be estimated based on previously measured or known mapping data. In this case, only RSSI is needed to estimate the distance between two devices, and the Measure Power value may not be needed.

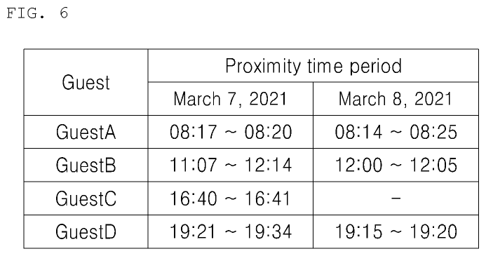

FIG. 6 shows an embodiment in which information on proximal users who has been present in the vicinity of the host device 100, that is, proximal user information, is displayed. The service server 200 may provide the host device 100 with a table as shown in FIG. 6 or information in a form corresponding thereto based on databased proximity context information. When referring to the table in FIG. 6, it can be seen that guests A to D were present in the vicinity of the host device 100 on Mar. 7, 2021, and a time zone in which each guest was in the vicinity thereof is also displayed. Likewise, it can be seen that the guest A, the guest B, and the guest D were present in the vicinity of the host device 100 on Mar. 8, 2021.

For reference, the table shown in FIG. 6 is provided on the assumption that the host device 100 or the guest device 300 utilizes only the monitoring function without the ranging function, and only the monitoring function is utilized therefor, and therefore, it can be seen that only times when the guest devices in the vicinity has entered into and exited from its proximity range are recorded.

Meanwhile, in implementing the service according to the present disclosure, a beacon module provided in the user device 100 may be naturally utilized, and in particular, when the user device 100 is a smartphone, a beacon module dependent on the user's location information service function category may be driven on the OS. The beacon module may be used in this way on a smartphone, but when implementing the service according to the present disclosure, GPS absolute location information may not be used. The security processing of GPS absolute location information may be considered as a feature capable of differentiating the service according to the present disclosure from other services in terms of personal information protection.

However, in implementing the service according to the present disclosure, there may be a need to include location information when recording or displaying an encounter between a host and a guest or between user devices. In this case, GPS information may be processed in such a manner that individual users can only check their own information on their own user devices. That is, GPS absolute location information may only be viewed on his or her own smartphone. Specifically, when checking a proximity between the host device 100 and the guest device 300, GPS absolute location information acquired by the host device 100 or GPS absolute location information acquired by the guest device 300 may be implemented so as not to be transmitted to the service server 200, but stored only on a user device such as the host device 100 or guest device 300, and the stored GPS absolute location information may be utilized only when showing proximal users who were present to the users later.

On the other hand, when accumulating and storing GPS absolute location information in a user device may cause a shortage of storage space in the user device, the GPS absolute location information acquired by the user device may be encrypted and shared with the service server 200 or another corresponding configuration (e.g., a separate dedicated server), and this information may be later received, decrypted, and utilized only when displaying the proximal users to users.

In this way, preventing sharing with the outside or securing the GPS absolute location information so as not to be viewed by anyone other than the user's device may prevent anyone other than the user from knowing the GPS absolute location information, and especially prevent a service provider who operates the service server 200 from knowing, thereby having an advantage in terms of security compared to other services that provide services using existing GPS absolute location information.

In summary, the user of the host device 100 may know where he or she had an encounter with proximal users based on his or her GPS absolute location information, and in some cases, the guest device 300 may also indirectly recognize the other person's location, but the service or application according to the present disclosure has an advantage in terms of personal information protection in that it does not acquire the other person's absolute GPS location information and does not share its own acquired GPS absolute location information with the outside.

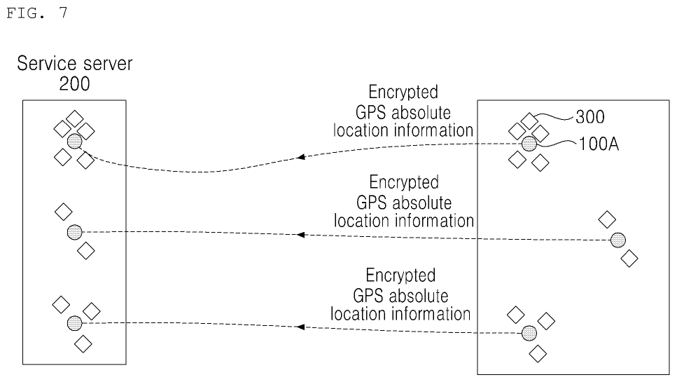

FIG. 7 shows a figure in which a host device 100A shares encrypted absolute location information with the service server 200. The host device 100A may acquire and store its own absolute location information (e.g., GPS information) when broadcasting an ad packet to the guest devices 300 in the vicinity, and the absolute location information acquired in this way may be encoded with a security key on the host device 100A and then shared with the service server 200. In this case, the service server 200 receives the encrypted absolute location information, but does not know what location information this information has, and merely performs the role of storing the encrypted absolute location information. Meanwhile, the service server 200 may retransmit the stored encrypted absolute location information later to the host device 100A, thereby allowing the absolute location information to be interpreted and utilized on the host device 100A.

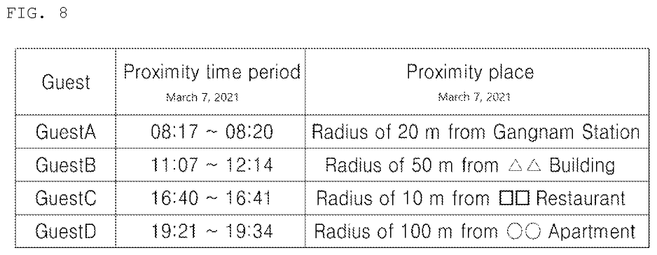

Meanwhile, FIG. 8 shows a table in which location information is further included in proximal user information. On the screen of the host device 100, as shown in FIG. 8, guest devices (guests) that were present in proximity thereto in the vicinity, a time period during which each guest device was present in proximity thereto, and a place (location information) where the host device 100 was located when each guest device was in proximity thereto may be further displayed. The location information may refer to GPS information recorded by the host device 100 itself, or the location information may be transmitted by the guest device when proximity context information is uploaded to the service server 200.

Meanwhile, the GPS information itself may be displayed in the proximal user information displayed on the screen of the host device 100, but the GPS information may generally consist of numerals and letters that are difficult for people to recognize, and therefore, it may also be implemented such that a major landmark corresponding to the corresponding location is displayed instead of the GPS information itself. FIG. 8 shows such examples, in which a place name, a building name, and the like that are easy for the general public to recognize, such as Gangnam Station, ΔΔ Building, □□ Restaurant, and oo Apartment, are shown instead. These landmarks may be pre-mapped to the GPS information. In other words, it may be predetermined that a certain landmark can be displayed when GPS information within a specific range is received.

On the other hand, it may be implemented such that not only a nearby landmark where the guest was present in proximity thereto, but also how far it is from the landmark, that is, information on a distance from the landmark, are displayed together on the screen of the host device 100. At this time, the distance information may be obtained by calculating based on the GPS information on the map information, and when considering a relatively low accuracy of GPS information, the distance information may be displayed in units of 10 m or 100 m scale so that only an approximate location can be easily recognized, such as within a radius of several tens of meters or within a radius of several hundreds of meters from the landmark.

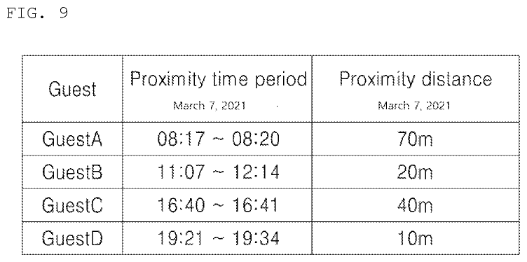

FIG. 9 is another example of proximal user information displayed on the host device 100, wherein proximity information on how far it is between the host device 100 and guest devices are is further displayed. In order to provide proximal user information as shown in FIG. 9, it is required that the ranging function of the host device 100 or guest device 300 is being activated, and a proximity distance between devices may be obtained through a distance calculation formula by means of RSSI and Measured Power introduced above.

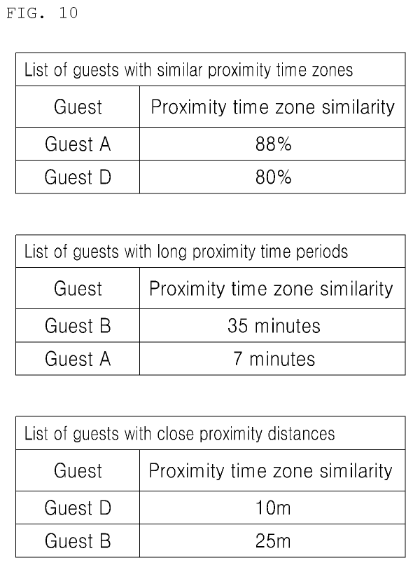

FIG. 10 shows another embodiment of proximal user information provided to the host device 100, wherein all guests who were present in the vicinity of the host device 100 are not displayed, but only some guests are selectively displayed.

Referring to FIG. 10, only highly relevant guests based on specific parameters, such as a “list of guests with similar proximity time zones,” a “list of guests with long proximity time periods” and a “list of guests with close proximity distances” may be selectively included in the proximal user information displayed on the host device 100. Those proximal users may be selected based on raw data received from the service server 200 by the host device 100, or may be directly selected by the service server 200 and then only its result may be transmitted to the host device 100. Additionally, whether the relevance is high based on a specific parameter may be determined depending on whether a value of the specific parameter is included in a preset range of values.

On the other hand, when referring to FIG. 10, the proximal user information displayed on the host device 100 may display not only a guest list with high relevance but also numerical values indicating the relevance. For example, on the list of guests with similar proximity time zones, numerical values indicating what percentage of time zones overlap when the host device 100 and the guest device are proximity to each other, how likely they are to meet each other in the same place, and the like may be displayed. In addition, how many minutes on average they are in proximity to each other on the list of guests with similar proximity time periods, and how far apart on average they are in proximity to each other on the list of guests with close proximity distances may be displayed as numerical values, thereby allowing the user of the host device 100 to use them as a reference in determining which guests to network with.

With reference to FIGS. 6 to 10, various embodiments of proximal user information displayed on the host device 100 have been described.

For a user who uses the service according to the present disclosure, there is an effect having an environment in which online or offline networking with those guests can be performed at any time while storing a list of other users (guests) who were in a spatially proximate space for a set period of time, such as a day, a week, a month, or the like. This can be seen as a differentiation from existing online chat services that randomly match members who do not know each other at all. In particular, in the case of many online chat services, most of the information voluntarily entered by users may be false and may violate personal information protection, so there are many cases of abuse as the identity of each user is unclear, whereas the service according to the present disclosure may have an effect of resolving the above problems to some extent by allowing arbitrary matching between people who were present in the same space.

In addition, the extension of networking members by means of the present disclosure may be continuously carried out through focusing on newly networked members, and for example, assuming that there are 10 friends who have met one another at one university, when these friends go to other schools to meet 10 other people, as a result, networking with 100 friends may be formed.

On the other hand, proximity context information or proximal user information to be stored in a database within the service server 200 may also be utilized to implement a voice call, video chat, and group meeting environment. For example, in the case of implementing an environment in which random video chatting for an unspecified number of members is carried out, when the unspecified number of members are filtered and limited to those who have encountered today or recently, a high-quality matching or meeting service may be provided based on the memory of the encounter.

A method of providing proximity a user networking service and a system therefor have been described above. Meanwhile, the present disclosure is not limited to the foregoing specific embodiments and application examples, it will be of course understood by those skilled in the art that various modifications may be made without departing from the gist of the present disclosure as defined in the following claims, and it is to be noted that those modifications should not be understood individually from the technical concept and prospect of the present disclosure.

1. A method of providing, by a service server, a proximal user networking service, the method comprising:
receiving proximity context information from a second user device; and
recording proximal user information based on a first user device based on the proximity context information,
wherein the proximity context information comprises at least part of information in an ad packet received by the second user device from the first user device through a near-field communication network.

2. The method of claim 1, wherein the ad packet comprises:
a UUID for identifying a service provided by the service server, the ad packet further comprising:
a community identifier for identifying a community established by a user of the first user device; or
a user identifier for identifying the user of the first user device.

3. The method of claim 2, wherein the proximity context information comprises:
at least the community identifier or user identifier, the proximity context further comprising:
timestamp information that records a time point at which an ad packet was received from the first user device; or
duration information that records a time period of coexistence within an effective near-field communication network between the first user device and the second user device.

4. The method of claim 3, wherein the proximity context information further comprises:
RSSI information that records a reception strength when the second user device receives the ad packet.

5. The method of claim 1, further comprising:
subsequent to performing, by the service server, recording proximal user information based on the first user device,
transmitting at least part of the proximal user information to the first user device.

6. The method of claim 1, further comprising:
receiving, by the service server, a community participation request that makes a request for participation in a community established by a user of the first user device from the second user device.

7. A method of operating a device to provide a proximal user networking service, the method comprising:
receiving a first ad packet from a first user device;
generating proximity context information comprising at least part of information included in the first ad packet; and
transmitting the proximity context information to a service server.

8. The method of claim 7, further comprising:
generating a second ad packet with reference to information included in the received first ad packet; and
broadcasting the second ad packet.

9. A method of operating a device to provide a proximal user networking service, the method comprising:
broadcasting an ad packet to arbitrary user devices;
receiving proximal person information from a service server; and
displaying at least part of the proximal person information through a screen of the device.

10. The method of claim 9, wherein the displaying of at least part of the proximal person information through the screen of the device further comprises displaying GPS information acquired by the device itself.

11. The method of claim 10, wherein the GPS information acquired by the device itself is encrypted by the device and then shared with the service server.
